(19) United States
(12) Patent Application Publication
(10) Pub. No.: US 2025/0042453 A1
(43) Pub. Date: Feb. 6, 2025

(54) DIGITAL CONTEXT-AWARE DATA COLLECTION

(71) Applicant: Ent. Services Development Corporation LP, Houston, TX (US)

(72) Inventors: Jonathan GIBSON, Austin, TX (US); Clifford Allan Wilke, Herndon, VA (US); Paul David THOMAS, Basingstoke (GB); Ben REES, Winchester (GB)

(73) Assignee: Ent. Services Development Corporation LP, Houston, TX (US)

(21) Appl. No.: 18/918,881

(22) Filed: Oct. 17, 2024

Related U.S. Application Data
(63) Continuation of application No. 18/305,614, filed on Apr. 24, 2023, now abandoned.
Application No. 18/305,614 is a continuation of application No. 17/076,652, filed on Oct. 21, 2020, now abandoned.
Application No. 17/076,652 is a continuation of application No. 15/753,939, filed on Feb. 20, 2018, now abandoned.

(51) Int. Cl. B61L 25/02; B61L 3/12; B61L 23/04; B61L 27/53; G06V 20/56; G07C 5/08; G08G 9/00

(52) U.S. Cl. CPC B61L 25/021; B61L 3/125; B61L 23/044; B61L 23/047; B61L 23/048; B61L 25/025; B61L 27/53; G06V 20/56; G07C 5/085; G07C 5/0866; G08G 9/00; B61L 2205/04

(57) ABSTRACT

Examples relate to digital context aware (DCA) data collection. In some examples, a DCA start location component is positioned at a first location along a travel route, and a DCA end location component is positioned at a second location along the travel route. In response to using a wireless interface to detect the DCA start location component, data collection of measurements by a sensor are initiated. In response to using the wireless interface to detect the DCA end location component, the data collection by the sensor is halted.

### CROSS-REFERENCE TO RELATED APPLICATIONS

This application is a continuation of U.S. application Ser. No. 18/305,614, filed Apr. 24, 2023, which is a continuation of U.S. application Ser. No. 17/076,652, filed Oct. 21, 2020, which is a continuation of U.S. application Ser. No. 15/753,939, filed Feb. 20, 2018, which is a national stage application pursuant to 35 U.S.C. § 371 of International Application No. PCT/US2015/046418, filed Aug. 21, 2015, the disclosure of which is hereby incorporated by reference herein.

### BACKGROUND

Transportation infrastructure (e.g., roadways, highways, toll ways, freeways, railways, etc.) is continuously maintained to ensure travel routes remain operable. To determine when maintenance should be done, the travel routes may be monitored to collect data that can be used to determine the condition of the routes. Examples of travel route monitoring include road traffic monitoring systems, railway monitoring systems, etc.

### BRIEF DESCRIPTION OF THE DRAWINGS

The following detailed description references the drawings, wherein:

FIG. 1 is a block diagram of an example computing device for digital context-aware (DCA) data collection;

FIG. 2 is a block diagram of an example system including a computing devices and DCA components for DCA data collection;

FIG. 3 is a flowchart of an example method for execution by a computing device for DCA data collection;

FIG. 4 is a flowchart of an example method for execution by a computing device for DCA data collection and uploading; and

FIG. 5 is a diagram of an example DCA data collection system for a railway.

### DETAILED DESCRIPTION

As detailed above, travel routes can be monitored to collect data that describes the condition of the routes. In some cases, large stretches of travel routes can be in remote areas that may involve using extensive resources to monitor. For example, railway tracks can be visually monitored, where any problems discovered are reported manually.

Examples herein describe an integrated system to monitor the conditions of travel routes (e.g., roadways, highways, toll ways, freeways, railways, etc.). The examples leverage a Digital Context-Aware (DCA) platform to utilize contextual information such as mechanical sensors, devices, and video/imaging technology to, for example, continuously monitor the conditions of a railway that is traveled on by locomotives and trains. The continual monitoring allows the example systems to proactively warn of travel route problems or potential problems.

The DCA platform adjusts the operation of computing device(s) based on the current context of the computing device(s). In other words, the operation of the device automatically changes depending on the context. In these examples, the context of a computing device can be used determined DCA location components.

In some examples, a digital context aware (DCA) start location component is positioned at a first location along a travel route, and a DCA end location component is positioned at a second location along the travel route. In response to using a wireless interface to detect the DCA start location component, data collection of measurements by a sensor are initiated. In response to using the wireless interface to detect the DCA end location component, the data collection by the sensor is halted.

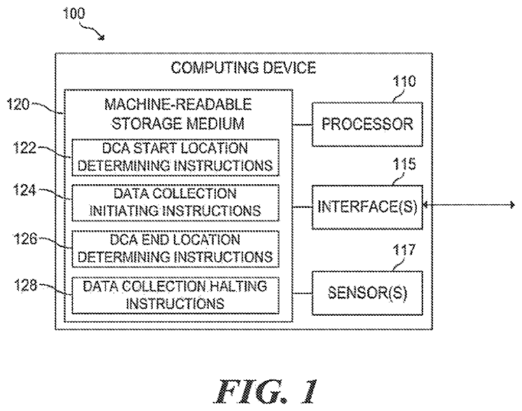

Referring now to the drawings, FIG. 1 is a block diagram of an example computing device 100 for providing visual analytics of spatial time series data using a pixel calendar tree. Computing device 100 may be any computing device (e.g., smartphone, tablet, laptop computer, desktop computer, etc.) capable of accessing data collected to monitor a travel route. In the embodiment of FIG. 1, computing device 100 includes a processor 110, an interface 115, sensor(s) 117, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to DCA data collection, as described below. As an alternative or in addition to retrieving and executing instructions, processor 110 may include one or more electronic circuits comprising a number of electronic components for performing the functionality of one or more of instructions 122, 124, 126, 128.

Interface(s) 115 may include a number of electronic components for communicating with DCA components and/or sensor devices. For example, interface(s) 115 may include an Ethernet interface, a Universal Serial Bus (USB) interface, an IEEE 1394 (Firewire) interface, an external Serial Advanced Technology Attachment (eSATA) interface, or any other physical connection interface suitable for communication with the sensors. Interface(s) 115 may also include a wireless interface such as a wireless local area network (WLAN) interface. The wireless interface has a longer range of operation (e.g., 60 meters or greater) in contrast to shorter range technologies such as near field communication (NFC). In operation, as detailed below, interface 115 may be used to send and receive data to and from a corresponding interface of DCA components and/or sensor devices.

Sensor(s) 117 may include a number of electronic components for making measurements as computing device 100 travels along a travel route. For example, sensor 117 may be an accelerometer that can be used to measure magnitude and direction of proper acceleration as well as orientation, vibration, shock, etc. In FIG. 1, sensor 117 is included in computing device 100; however, in other cases, sensor 117 can be an external device that is accessed via interface 115.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for DCA data collection.

DCA start location determining instructions 122 detects a DCA start location component. Computing device 100 can use interface 115 to detect DCA components. For example, interface 115 may be a wireless interface that can detect a radio frequency (RF) signal emitted by the DCA start location component. In this example, the DCA start location component may provide DCA start location determining instructions 122 with a DCA component type and an identifier that uniquely identifies the DCA start location component. In some cases, the DCA start location component may also specify a type of data (e.g., accelerometer data, video data, etc.) to be collected.

Data collection initiating instructions 124 initiate data collection by sensor(s) 117. The data collection can be triggered in response to detect the DCA start location component as described above. Sensor(s) 117 may collect various types of data that can be used to determine the condition of the traveling route. For example, vibration and shock data for can be collected and used to determine if the travel route is uneven (e.g., shocks from potholes or damaged rails, etc.). In some cases, various types of data collection can be initiated based on the type of data specified by the DCA start location. For instance, the DCA start location component may specify that accelerometer and video data should be collected.

DCA end location determining instructions 126 detect a DCA end location component. Similar to as described above, computing device 100 can use interface 115 to detect the DCA end location component. The DCA end location component may provide identifying information that can be used to pair it with the DCA start location component detected above.

Data collection halting instructions 128 halt the data collection by sensor(s) 117. The data collection can be halted in response to detect the DCA end location component as described above. In this manner, the period of time between the start location and end location can be designated as a period for data collection. The identifiers of the start and/or end location can then be associated with the data collected so that the collected data can be used to determine the condition of the travel route between the start and end location.

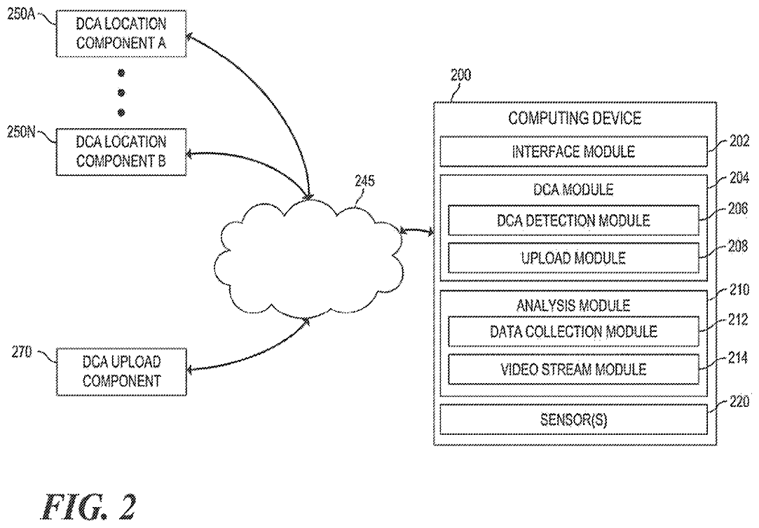

FIG. 2 is a block diagram of an example computing device 200 in communication via a computer network 245 with DCA components (e.g., DCA location component A 250A, DCA location component N 250N, DCA upload component 270). As used herein, a computer network may include, for example, a local area network (LAN), a wireless local area network (WLAN), a virtual private network (VPN), the Internet, or the like, or a combination thereof. In some examples, a computer network may include a telephone network (e.g., a cellular telephone network). As illustrated in FIG. 2 and described below, computing device 200 may communicate with DCA components to provide DCA data collection.

As illustrated, computing device 200 may include a number of modules 202-220. Each of the modules may include a series of instructions encoded on a machine-readable storage medium and executable by a processor of the computing device 200. In addition or as an alternative, each module may include one or more hardware devices including electronic circuitry for implementing the functionality described below.

As with computing device 100 of FIG. 1, computing device 200 may be a smartphone, notebook, desktop, tablet, workstation, mobile device, or any other device suitable for executing the functionality described below. As detailed below, computing device 200 may include a series of modules 202-220 for providing visual analytics of spatial time series data using a pixel calendar tree.

Interface module 202 may manage communications with the DCA components (e.g., DCA location component A 250A, DCA location component N 250N, DCA upload component 270). Specifically, the interface module 202 may initiate connections with the DCA components to send and receive context data (e.g., DCA component identifiers, DCA component types, data collection type, etc.).

DCA module 204 may manage context data obtained from DCA components (e.g., DCA location component A 250A, DCA location component N 250N, DCA upload component 270). For example, context data for determining a current context can be obtained by data detection module 206 from a DCA location component A 250A. The current context may be used to determine the operating mode of analysis module 210 as described below. Various location components (e.g., DCA location component A 250A, DCA location component N 250N) may be installed along a travel route to create different contexts for data collection. In this example, as each of the different contexts is reached, data collection may be triggered according to each context by analysis module 210.

Data detection module 206 may obtain context data such as a component identifier and a component type (e.g., DCA start type, DCA end type, DCA upload type) from DCA components (e.g., DCA location component A 250A, DCA location component N 250N, DCA upload component 270). The context data is used by data detection module 206 to determine the current context. The context can be provided to the analysis module 210 for further processing.

Upload module 208 may upload collected data from analysis module 208 to DCA upload component 270. When a DCA upload component 270 is detected by data detection module 206, upload module 208 may initiate an upload of the collected data to DCA upload component 270, which can relay the collected data to a further destination. For example, the collected data may be uploaded to a centralized repository for processing. Upload module 208 allows for vast amounts of information to be collected along travel routes so that the condition of travel routes can be analyzed as a whole to identify trends.

Analysis module 210 manages data collection by sensor(s) 220. Specifically, data collection module 212 of analysis module 210 can control the data collection according to the current context of computing device 200. For example, data collection module 212 can initiate the data collection at DCA start location components and can halt the data collection at DCE end location components. Data collection module 212 may store the collected data in a local storage device (not shown). Storage device may be any hardware storage device for maintaining data accessible to computing device 200. For example, storage device may include memory, hard disk drives, solid state drives, tape drives, and/or any other storage devices. The storage device may be located in computing device 200 as shown and/or in another device in communication with computing device 200.

Video stream module 214 of analysis module 210 may interact with a video capture device (not shown) to obtain a video stream of the travel route. Similar to data collection, the capture of the video stream may be initiated and halted based on the current context of computing device 200. As the video stream is captured, video stream module 214 can store the stream on the storage device for analysis and/or uploading.

Sensor(s) 220 may be any sensor device(s) that is suitable for collecting measurements (e.g., video stream, acceleration, temperature, etc.) related to a travel route. Sensor(s) 220 may be configured to collect measurements continuously or at regular intervals while active.

DCA location components 250A, 250N may be any computing device that is suitable for specifying a context for computing device as described above. For example, a DCA location component (e.g., DCA location component A 250A, DCA location component N 250N) can be used to designate a start location (e.g., DCA start location component) or an end location (e.g., DCA end location component) for a context, where the context is active between the start and end location.

DCA upload component 270 may be any computing device that is suitable for relaying data from computing device 200 as described above. For example, DCA upload component 270 can include a radio (not shown) for connection to a mobile network, where collected data from computing device 200 is relayed to the centralized repository via the mobile network. DCA upload component 270 can identify itself as an upload type to computing device 200 to initiate the relay of data.

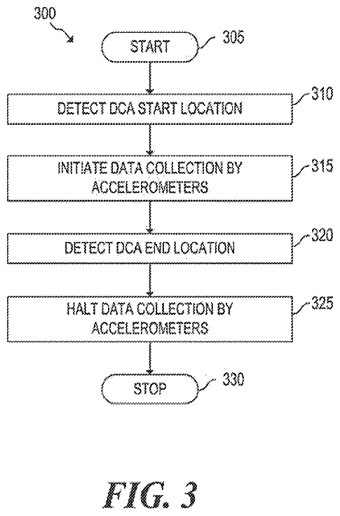

FIG. 3 is a flowchart of an example method 300 for execution by a computing device 100 for DCA data collection. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 detects a DCA start location component. Computing device 100 may be mounted on or otherwise installed in a vehicle that is traveling along a travel route. In this example, computing device 100 may determine that a DCA component is nearby by using a RF radio to detect the DCA component as it is passed by the vehicle. In block 315, computing device 100 initiates data collection by sensor(s) in response to detecting the DCA start location component. Sensor(s) may collect various types of data (e.g., vibration data, shock data, video stream) that can be used to determine the condition of the traveling route.

In block 320, computing device 100 detects a DCA end location component. In block 325, computing device 100 halts data collection by the sensor(s) in response to detecting the DCA end location component. The collected data may be associated with a DCA identifier that was provided by the DCA start location component and/or the DCE end location component. Method 300 may then continue to block 330, where method 300 may stop.

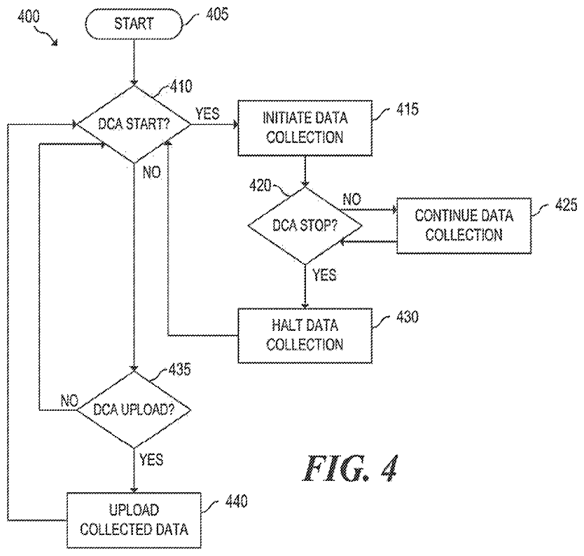

FIG. 4 is a flowchart of an example method 400 for execution by a computing device 200 for DCA data collection and uploading. Although execution of method 400 is described below with reference to computing device 200 of FIG. 2, other suitable devices for execution of method 400 may be used, such as computing device 100 of FIG. 1. Method 400 may be implemented in the form of executable instructions stored on a machine-readable storage medium and/or in the form of electronic circuitry.

Method 400 may start in block 405 and continue to block 410, where computing device 200 determines if a DCA start location component is detected. If a DCA start location component is detected, computing device 200 initiates data collection by sensor(s) in block 415. Sensor(s) may collect various types of data (e.g., vibration data, shock data, video stream) that can be used to determine the condition of the traveling route. In block 420, computing device 200 determines if a DCA end location component is detected. So long as a DCA end location component is not detected, computing device 200 continues the data collection in block 425.

If a DCE end location component is detected, computing device 200 halts data collection by the sensor(s). The collected data may be associated with a DCA identifier that was provided by the DCA start location component and/or the DCE end location component. At this stage, method 400 may return to block 41 Oto begin searching for the next DCA start location component.

If a DCA start location component is not detected, computing device determines if a DCA upload component is detected in block 435. If a DCA upload component is detected, computing device 200 uploads the collected data to a central repository via the DCA upload component. At this stage, method 400 may return to block 410 to determine if the next DCA start location component is detected.

In this manner, computing device 200 can collect data at various locations along the travel route, where each set of DCA start and end location components may be designated as a separate set of data. Accordingly, conditions along the travel route can be determined based on the collected data after the data is uploaded to the central repository. Because the data is automatically collected and uploaded, hazardous conditions or potential issues along the travel route can be addressed in a timely fashion.

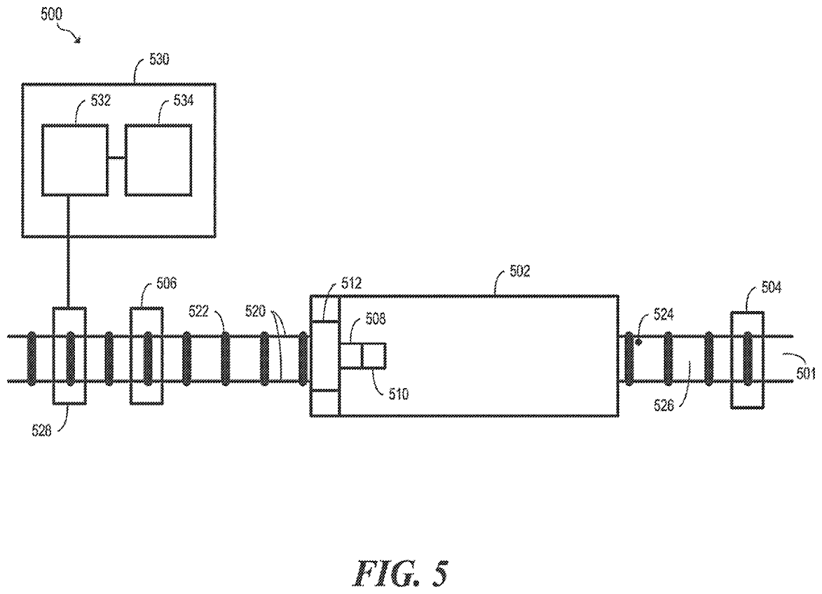

FIG. 5 is a diagram of an example DCA data collection system 500 for a railway 501. As shown, a train 502 runs on the railway 501. When the train 502 (e.g., locomotive, train car, etc.) crosses through the DCA start location component 504, the DCA data collection and inspection of the railway 501 is initiated. Similarly, when the train 502 crosses the DCA end location component 506, the DCA data collection and inspection of the railway 501 is halted. Multiple DCA start location components 504 and DCA end location components 506 can be configured along the railway 501. Accelerometer embedded in computing device(s) 508 are attached firmly to the locomotive portion of the train 502 (e.g., the computing device(s) 508 can be attached to the dash of the locomotive). The computing device(s) 508 can have local compute power, storage, a wireless interface, and global positioning system (GPS) capabilities. The train 502 can provide a continuous power source for the computing device(s) 508. The wireless interface has a longer range of operation (e.g., 60 meters or greater) to facilitate communication with the DCA components (e.g., DCA start location component 504, DCA end location component 506, DCA upload component 528, etc.).

While the DCA data collection and inspection is active, the sensors embedded in the computing device(s) 508 can collect measurements (e.g., vibration and shock data collected by an accelerometer, coordinates collected by a GPS module, timestamps collected by a timing module, etc.). A video stream can also be captured by a camera 512 and stored in a video/imaging ring buffer 510. If the GPS signal is blocked, for example, due to the train 502 going through a tunnel, extrapolation algorithms can determine approximate GPS coordinates based on the last GPS coordinates received before entering the tunnel and the speed of the train 502.

A snippet of video/imaging from the video/image ring buffer 510 can be saved to a file on the camera 512 or on the video/imaging ring buffer 51 Oat a pre-defined and configurable timeframe based on the context established by DCA location components. In some cases, camera 512 may be a hyperspectral camera. The size of the video/imaging ring buffer 510 can be pre-defined and is based on configurable settings stored on the camera 512. The video/imaging snippet files can be used for automated post processing analytics to determine the condition of the rails 520, ties 522, spikes 524, and rail bed 526 at a particular point in time or over time.

Maps can be generated based on data collected along the railway 501, and multiple log files can be tied to each context. For example, the user can click or touch graphical representation of the log file(s) mapped along the railway 501 to review the details of the selected log file(s). The graphical representation of the log file(s) mapped along the railway 501 can be in the form of different shapes, colors, etc. signifying multiple log files and/or the severity or risk of the track at the selected location.

Once the train 502 comes within range of a DCA upload component 528, the computing device(s) 508 can start uploading the collected data and video/imaging to a central repository 530. Compute resources 532 and analytic components 534 of the central repository 530 can process the log files to determine issues with components of the railway 501 such as the rails 520, ties 522, spikes 524, and rail bed 526 at a particular point in time or over time.

The foregoing disclosure describes a number of example of DCA data collection. In this manner, the examples disclosed herein DCA data collection along a travel route by using DCA components to establish contexts and to upload collected data to a central repository.

1. A system comprising:
a computing device comprising a processor and a machine-readable medium with instructions that, when executed by the processor cause the system to:
detect, by a wireless interface, a digital context aware (DCA) start location component positioned at a first location along a travel route;
initiate data collection of vibration measurements by an accelerometer and capture of a video stream by a camera device in response to the detection of the DCA start location component;
detect, by the wireless interface, a DCA end location component positioned at a second location along the travel route; and
halt the data collection by the accelerometer and the capture of the video stream by the camera device in response to the detection of the DCA end location component.

2. The system of claim 1, further comprising the camera device, wherein the DCA start location component is detected based on a signal emitted by the DCA start location component, the signal identifies the DCA start location component, and the signal specifies a type of data to be collected.

3. The system of claim 1, wherein the travel route is a railway, and wherein the camera device is a hyperspectral camera that is targeted at the railway.

4. The system of claim 3, wherein the camera device is mounted to a train on the railway.

5. The system of claim 1, wherein the instructions further cause the system to:
detect a DCA upload component;
upload the vibration measurements and the video stream to a centralized repository in response to the detection of the DCA upload component.

6. The system of claim 1, wherein the instructions further cause the system to determine coordinates associated with the vibration measurements based on a global positioning system (GPS).

7. A method for digital context aware (DCA) data collection, the method comprising:
detecting, by a wireless interface, a DCA start location component that is positioned at a first location along a travel route;
initiating data collection of measurements by a sensor and capture of a video stream by a camera device in response to the detecting the DCA start location component;
detecting, by the wireless interface, a DCA end location component that is positioned at a second location along the travel route; and
halting the data collection by the sensor and the capture of the video stream in response to the detecting the DCA end location component.

8. The method of claim 7,
wherein the DCA start location component is detected based on a signal emitted by the DCA start location component, the signal identifies the DCA start location component, and the signal specifies a type of data to be collected.

9. The method of claim 7, wherein the travel route is a railway, the camera device is a hyperspectral camera that is targeted at the railway, and the sensor is an accelerometer.

10. The method of claim 9, wherein the camera device is mounted to a train on the railway.

11. The method of claim 7, further comprising determining coordinates associated with the measurements based on a global positioning system (GPS).

12. A non-transitory machine-readable storage medium encoded with instructions executable by a processor, the machine-readable storage medium comprising instructions to:
detect, by a wireless interface, a digital context aware (DCA) start location component positioned at a first location along a railway;
initiate data collection of measurements by a sensor and capture of a video stream by a camera device in response to the detection of the DCA start location component;
detect, by the wireless interface, a DCA end location component positioned at a second location along the railway; and
halt the data collection by the sensor and the capture of the video stream by the camera device in response to the detection of the DCA end location.

13. The non-transitory machine-readable storage medium of claim 12,
wherein the DCA start location component is detected based on a signal emitted by the DCA start location component, the signal identifies the DCA start location component, and the signal specifies a type of data to be collected.

14. The non-transitory machine-readable storage medium of claim 12, wherein the camera device is a hyperspectral camera that is targeted at the railway and the camera device is mounted to a train on the railway.

15. The non-transitory machine-readable storage medium of claim 12, wherein the instructions are further to determine coordinates associated with the measurements based on a global positioning system (GPS).

16. The system of claim 1, wherein the instructions further cause the system to generate a map based on the vibration measurements and the video stream, wherein a log file that includes the vibration measurements and the video stream is accessible through a graphical representation corresponding to the travel route on the map.

17. The method of claim 7, further comprising:
detecting, by the wireless interface, a DCA upload component; and
uploading the measurements and the video stream to a centralized repository.

18. The method of claim 7, further comprising generating a map based on the measurements and the video stream, wherein a log file that includes the measurements and the video stream is accessible through a graphical representation corresponding to the travel route on the map.

19. The non-transitory machine-readable storage medium of claim 12, wherein the instructions are further to:
detect, by the wireless interface, a DCA upload component; and
upload the measurements and the video stream to a centralized repository.

20. The non-transitory machine-readable storage medium of claim 12, wherein the instructions are further to generate a map based on the measurements and the video stream, wherein a log file that includes the measurements and the video stream is accessible through a graphical representation corresponding to the travel route on the map.
